(19) United States
(12) Patent Application Publication
(10) Pub. No.: US 2026/0177745 A1
(43) Pub. Date: Jun. 25, 2026

(54) OPTO-ELECTRONIC CIRCUITS FOR OPTICAL POWER LIMITING

(71) Applicant: GlobalFoundries U.S. Inc., Malta, NY (US)

(72) Inventors: Meenatchisundaram Subramanian, Virudhunagar (IN); Riddhi Nandi, Bangalore (IN); Venkatesh Mohanakrishnaswamy, Chennai (IN); Vaibhav Anantrai Ruparelia, Bengaluru (IN)

(21) Appl. No.: 18/989,085

(22) Filed: Dec. 20, 2024

(51) Int. Cl. G02B 6/122; G02B 6/12

(52) U.S. Cl. CPC G02B 6/122; G02B 2006/12061

(57) ABSTRACT

A structure includes: a photonic integrated circuit (PIC) with power detection and reduction photonic elements coupled to a waveguide near input and output ports, respectively; and an electronic integrated circuit (EIC) between the power detection and reduction photonic elements to reduce the power level of the optical signal near the output port when an over-power condition is detected. In some embodiments, the PIC includes first and second PIN photodiodes coupled to a waveguide near input and output ports, respectively. The first PIN photodiode is reverse biased, generating a sense current (Isen). The EIC receives Isen, detects when Isen is greater than a reference current (Iref) indicating detection of the over-power condition and, in response to the over-power condition, applies a bias voltage to forward bias the second PIN photodiode. Such forward biasing injects current into the waveguide near the output port and reduces the power level of the optical signal.

### BACKGROUND

The present disclosure relates to optical power control in photonic integrated circuits (PICs) and, more particularly, to embodiments of an opto-electronic circuit that provides over-power protection in a PIC and associated methods of operating the circuits.

More particularly, a PIC can include a waveguide, which receives an optical signal (e.g., from an off-chip optical fiber or from some other optical signal source, such as a laser). If, however, the optical signal is over-powered, the PIC or a portion thereof (e.g., an active or passive photonic device downstream of the waveguide) may be susceptible to damage.

### SUMMARY

Generally, disclosed herein are embodiments of an opto-electronic structure and, particularly, a co-packaged optics (CPO) structure. This structure can include a photonic integrated circuit (PIC). The PIC can include a waveguide, which has an input port and an output port. The PIC can further include a first photonic element and a second photonic element. The first photonic element can be coupled to the waveguide adjacent the input port and can detect the power level of an optical signal received at the input port. The second photonic element can be coupled to the waveguide between the first photonic element and the output port. The structure can further include an electronic integrated circuit (EIC), which is connected to the first photonic element and to the second photonic element. The EIC can cause the second photonic element to reduce the power level of the optical signal adjacent to the output port, when the power level of the optical signal detected by the first photonic element is above a threshold power level.

More specifically, some embodiments of a structure disclosed herein can include a PIC. The PIC can include a waveguide, which has an input port and an output port. The PIC can further include a first photonic element and a second photonic element. The first photonic element can be first photodiode. The first photodiode can be coupled to the waveguide adjacent the input port and can detect the power level of an optical signal received at the input port. The second photonic element can be a second photodiode and can be coupled to the waveguide between the first photonic element and the output port. The structure can further include an EIC, which is connected to the first photonic element and to the second photonic element. The EIC can cause the second photonic element to reduce the power level of the optical signal adjacent to the output port, when the power level of the optical signal detected by the first photonic element is above a threshold power level.

Other embodiments of a structure disclosed herein can include a PIC. The PIC can include a waveguide, which has an input port and an output port. The PIC can further include first photonic element and a second photonic element. The first photonic element can be a photodiode, which is coupled to a tap on the waveguide adjacent the input port and which detects a power level of an optical signal received at the input port. The second photonic element can be coupled to the waveguide between the tap and the output port and can include: a splitter; a coupler-splitter; a pair of waveguide branches extending between the splitter and the coupler-splitter with at least one of the waveguide branches including a phase shifter. The structure can also include an EIC, which is connected to the first photonic element and the second photonic element. The EIC can cause the second photonic element to reduce the power level of the optical signal adjacent to the output port, when the power level of the optical signal detected by the first photonic element is above a threshold power level.

Also, disclosed herein are associated method embodiments for operating such structures. An embodiment of a method can include providing a structure including a PIC and an EIC. The PIC can include a waveguide, which has an input port and an output port. The PIC can further include a first photonic element and a second photonic element. The first photonic element can be coupled to the waveguide adjacent the input port. The second photonic element can be coupled to the waveguide between the first photonic element and the output port. The EIC can be connected to the first photonic element and to the second photonic element. The method can further include detecting, by the first photonic element, the power level of an optical signal received at the input port. The method can further include causing, by the EIC, the second photonic element to reduce the power level of the optical signal adjacent to the output port, when the power level of the optical signal detected by the first photonic element is above a threshold power level.

Another embodiment of a method can include providing a structure including a PIC and an EIC. The PIC can include a waveguide, which has an input port and an output port. The PIC can further include a first photonic element and a second photonic element. The first photonic element can be first photodiode coupled to the waveguide adjacent the input port. The second photonic element can be a second photodiode coupled to the waveguide between the first photonic element and the output port. The EIC can be connected to the first photonic element and to the second photonic element. The method can further include detecting, by the first photonic element, the power level of an optical signal received at the input port. The method can further include causing, by the EIC, the second photonic element to reduce the power level of the optical signal adjacent to the output port, when the power level of the optical signal detected by the first photonic element is above a threshold power level.

Yet another embodiment of a method can include providing a structure including a PIC and an EIC. The PIC can include a waveguide, which has an input port and an output port. The PIC can further include first photonic element and a second photonic element. The first photonic element can be a photodiode, which is coupled to a tap on the waveguide adjacent the input port. The second photonic element can be coupled to the waveguide between the tap and the output port and can include: a splitter; a coupler-splitter; a pair of waveguide branches extending between the splitter and the coupler-splitter with at least one of the waveguide branches including a phase shifter. The EIC can be connected to the first photonic element and the second photonic element. The method can further include detecting, by the first photonic element, a power level of an optical signal received at the input port. The method can further include causing, by the EIC, the second photonic element to reduce the power level of the optical signal adjacent to the output port, when the power level of the optical signal detected by the first photonic element is above a threshold power level (e.g., by rerouting a portion of the optical signal to a secondary output port).

It should be noted that all aspects, examples, and features of disclosed embodiments mentioned in the summary above can be combined in any technically possible way. That is, two or more aspects of any of the disclosed embodiments, including those described in this summary section, may be combined to form implementations not specifically described herein. The details of one or more implementations are set forth in the accompanying drawings and the description below. Other features, objects and advantages will be apparent from the description and drawings, and from the claims.

### BRIEF DESCRIPTION OF THE DRAWINGS

The present disclosure will be better understood from the following detailed description with reference to the drawings, which are not necessarily drawn to scale and in which:

FIG. 1 is a schematic diagram illustrating generally disclosed embodiments of a co-packaged optics (CPO) structure;

FIG. 2 is a schematic diagram illustrating, more specifically, some disclosed embodiments of a CPO structure;

FIG. 3 is a schematic diagram illustrating other disclosed embodiments of a CPO structure;

FIGS. 4A and 4B are diagrams illustrating examples of delay lines that can be incorporated into the structures of FIGS. 1-3; and

FIGS. 5A-5D are cross-section diagrams illustrating different configurations that could be employed to implement the CPO structures of FIGS. 1-3.

### DETAILED DESCRIPTION

As mentioned above, a PIC can include a waveguide, which receives an optical signal (e.g., from an off-chip optical fiber or from some other optical signal source, such as a laser). If, however, the optical signal is over-powered, the PIC or a portion thereof (e.g., an active or passive photonic device downstream of the waveguide) may be susceptible to damage. For purposes of this disclosure, “an over-powered” optical signal refers to an optical signal at a power level above a threshold power level (e.g., a predetermined maximum operating power level) for the PIC.

In view of the foregoing, disclosed herein are embodiments of an opto-electronic circuit structure and, more particularly, embodiments of a co-packaged optics (CPO) structure and associated operating method embodiments. The CPO structure includes: a photonic integrated circuit (PIC) with power detection and reduction photonic elements coupled to a waveguide near input and output ports, respectively; and an electronic integrated circuit (EIC) including control circuitry connected between the power detection and reduction photonic elements to reduce the power level of the optical signal near the output port when an over-power condition is detected. In some embodiments, the PIC can include a waveguide and first and second PIN photodiodes in line with and coupled to the waveguide near the input and output ports, respectively. The first PIN diode can be reverse biased to generate a sense current (Isen). The EIC can include control circuitry that receives the Isen, that detects when Isen is greater than a reference current (Iref) indicating detection of an over-power condition, and that, in response, applies an appropriate bias voltage to forward bias the second PIN photodiode. By forward biasing the second PIN photodiode, current is injected into the waveguide, increasing free carriers, and reducing the power level of the optical signal near the output port. In other embodiments, the PIC can include a waveguide, a first photonic element (e.g., a photodiode) on a tap off the waveguide near the input port and a second photonic element (e.g., a combination of phase shifter(s) and a coupler-splitter, such as a multi-mode interferometer (MMI)) coupled to the waveguide near a primary output port. In these embodiments, the photodiode can be reverse biased to generate a Isen. The EIC can include control circuitry that receives Isen, that detects when Isen is greater than a reference current (Iref) indicating the occurrence of an over-power condition, and that, in response, applies an appropriate bias voltage to the phase shifter(s). In response to some phase shifting, the coupler-splitter reroutes a portion of the optical signal to a secondary output port and, as a result, the power level of the remaining optical signal at the primary output port is effectively reduced.

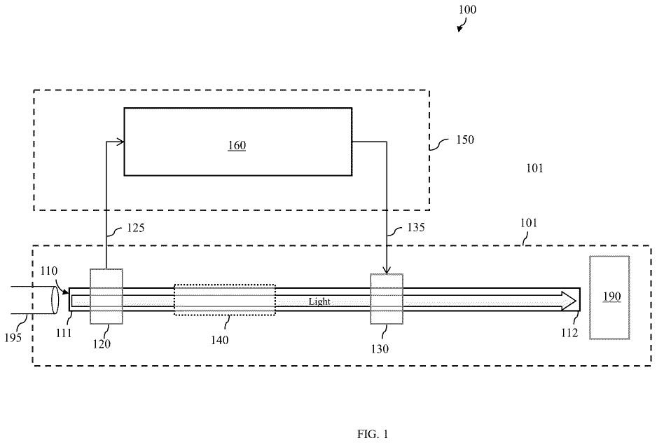

FIG. 1 is a schematic diagram illustrating, generally, embodiments of a co-packaged optics (CPO) structure 100. CPO structure 100 includes: a photonic integrated circuit (PIC) 101 and an electronic integrated circuit (EIC) 150. PIC 101 can include a waveguide 110 and first and second photonic elements 120-130 (also referred to herein as power detection and power reduction photonic elements) coupled near input and output ports 111-112, respectively, of waveguide 110. EIC 150 can include control circuitry 160 (also referred to herein as feed forward control circuitry or optical-electrical-optical control circuitry) connected between the first and second photonic elements 120-130 and configured to reduce the likelihood of and ideally prevent the occurrence of damage-causing over-power conditions within PIC 101.

More specifically, CPO structure 100 includes PIC 101. PIC 101 can include a waveguide 110 on a chip substrate. Waveguide 110 can include a core with any now known or subsequently developed waveguide shape. For example, core of waveguide 110 could have any of the following waveguide shapes: a strip shape (also referred to herein as wire shape), a rib shape (also referred to herein as a ridge shape), a slot shape, or a surface-wave (SW) shape. Waveguide 110 can include: a core material, which makes up the waveguide shape; and cladding material, which surrounds the core material. Such waveguide shapes are well known in the art and, thus, the details thereof have been omitted from the specification to allow the reader to focus on the salient aspects of the disclosed embodiments. In any case, the core of waveguide 110 can be surrounded by cladding in order to facilitate and control optical signal propagation along the core.

The cladding material can have a smaller refractive index (n) than the core material that it surrounds. For example, the core material could be monocrystalline silicon with a refractive index of 3.3 to 3.6 and the cladding material could be a dielectric material with a smaller refractive index (e.g., silicon nitride with a refractive index of approximately 2.0). Alternatively, the core material could be silicon nitride with a refractive index of approximately 2.0 and the cladding material could be silicon dioxide with a refractive index of less than approximately 1.6. The example core and cladding materials mentioned above are provided for illustration purposes and are not intended to be limiting. Alternatively, any other suitable combination of core and cladding materials could be employed for waveguide 110 as long as the cladding material has a smaller refractive index than the core material. The following is a list of additional examples of photonics materials from which cladding and core materials could be selected as long as the selected cladding material has a smaller refractive index than the selected core material: silicon, n˜3.30-3.60; polysilicon, n˜3.90; hafnium dioxide, n˜2.08; zirconium dioxide (Zirconia), n˜2.12; silicon nitride, n˜2.00; silicon oxynitride, n˜1.46-2.10; aluminum nitride, n˜2.10-2.40; titanium dioxide, n˜2.45; zinc monoxide, n˜1.93; aluminum oxide, n˜1.75; magnesium oxide, n˜1.72; silicon dioxide, n˜1.45; calcium fluoride, n˜1.43; magnesium fluoride, n˜1.37; etc.

In any case, waveguide 110 can further include an input port 111 and an output port 112. Input port 111 can, for example, be coupled to an optical signal source 195 for receiving an optical signal. The optical signal source 195 could, for example, be an off-chip optical fiber (as illustrated). Such an off-chip optical fiber can be coupled to the input port 111 by a grating coupler, an edge coupler, an evanescent coupler, or any other suitable type of optical fiber-to-waveguide coupler. Alternatively, the optical signal source can be any other type of now known or subsequently developed optical signal source (e.g., a laser). Output port 112 can be coupled to at least one additional photonic element 190 of PIC 101. Additional photonic element 190 can be any type of active or passive photonic device coupled to the output port 112 of waveguide 110 to receive the optical signal. This additional photonic element 190 can have a predetermined maximum operating power level. That is, it may be susceptible to damage if a received optical signal waveguide 110 has a power level above the maximum operating power level.

PIC 101 can include first and second photonic elements 120-130 (also referred to herein as power detection and power reduction photonic elements) coupled to waveguide 110. Specifically, first photonic element 120 can be coupled to waveguide 110 adjacent (but downstream of) input port 111. First photonic element 120 can include one or more components (as discussed in greater detail below with regard to specific embodiments) and the component(s) can be configured to detect the power level of an optical signal near input port 111 (e.g., by sensing the power level of the optical signal and, in response, generating and outputting a first electrical parameter 125 indicative of the power level). Second photonic element 130 can be coupled to waveguide 110 adjacent, but upstream of output port 112. Second photonic element 130 can include one or more components (as discussed in greater detail below with regard to specific embodiments) and the component(s) can be configured to reduce the power level of the optical signal before it is output from output port 112 (e.g., by receiving a second electrical parameter 135 and, in response to the second electrical parameter 135, injecting free carriers into the optical signal, rerouting a portion of the optical signal, or otherwise reducing the power level of the optical signal at output port 112).

EIC 150 can include control circuitry 160 electrically connected to first photonic element 120 and second photonic element 130. Specifically, control circuitry 160 can be configured to receive first electrical parameter 125 from first photonic element 120. Control circuitry 160 can further be configured to detect whether and by how much the power level of the optical signal (as indicated by first electrical parameter 125) is above a threshold power level (e.g., a maximum operating power level) and, based thereon, generate and output second electrical parameter 135 to second photonic element 130. It should be noted that the level of second electrical parameter 135 can be variable to enable fine tuning of the power level and, particularly, to reduce the power level so that it is at or below the threshold power level.

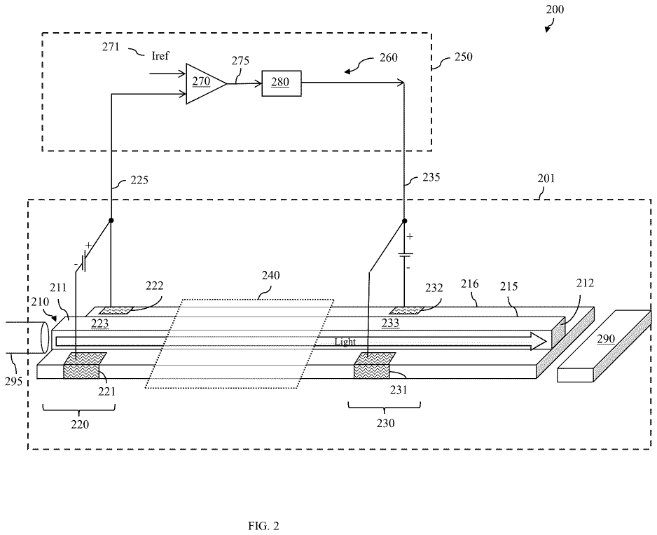

FIG. 2 is a schematic diagram illustrating an example of a CPO structure 200, according to some embodiments. CPO structure 200 includes: a photonic integrated circuit (PIC) 201 and an electronic integrated circuit (EIC) 250. PIC 201 can include a waveguide 210 and first and second photonic elements 220-230 and, more particularly, first and second PIN photodiodes (as discussed in greater detail below) coupled near input and output ports 211-212, respectively, of waveguide 210. EIC 250 can include control circuitry 260 connected between the first and second photonic elements 220-230 and configured to reduce the likelihood of and ideally prevent the occurrence of damage-causing over-power conditions within PIC 201.

More specifically, CPO structure 200 includes PIC 201. PIC 201 can include a waveguide 210 on a chip substrate. Waveguide 210 can be, for example, a rib waveguide. Those skilled in the art will recognize that a rib waveguide (also referred to herein as a ridge waveguide) includes a slab portion 216 and a strip portion 215 on and narrower in width than the slab portion 216. That is, strip portion 215 can be center aligned on slab portion 216 and sides of slab portion 216 can extend laterally beyond opposing sidewalls of strip portion 215. Waveguide 210 can include: a core material, which makes up the rib waveguide shape; and cladding material, which surrounds the core material. In CPO structure 200, waveguide 210 can include a semiconductor core material (e.g., monocrystalline silicon, monocrystalline silicon germanium, etc.). The cladding material can be any suitable dielectric cladding material with a smaller refractive index than the monocrystalline semiconductor core material. For example, if the core material of waveguide 210 is monocrystalline silicon, the cladding material could be any of silicon dioxide, silicon nitride, or some other dielectric cladding material with a smaller refractive index than the core material.

In any case, waveguide 210 can further include an input port 211 and an output port 212. Input port 211 can, for example, be coupled to an optical signal source 295 for receiving an optical signal. The optical signal source 295 could, for example, be an off-chip optical fiber (as illustrated). Such an off-chip optical fiber can be coupled to the input port 211 by a grating coupler, an edge coupler, an evanescent coupler, or any other suitable type of optical fiber-to-waveguide coupler. Alternatively, the optical signal source can be any other type of now known or subsequently developed optical signal source (e.g., a laser). Output port 212 can be coupled to at least one additional photonic element 290 of PIC 201. Additional photonic element 290 can be any type of active or passive photonic device coupled to the output port 212 of waveguide 210 to receive the optical signal. This additional photonic element 290 can have a predetermined maximum operating power level. That is, it may be susceptible to damage if a received optical signal waveguide 210 has a power level above the maximum operating power level.

PIC 201 can include first and second photonic elements 220-230 (also referred to herein as power detection and power reduction photonic elements) coupled to waveguide 210.

Specifically, first photonic element 220 can be an active photonic device in-line with (i.e., integrated with) waveguide 210 adjacent, but downstream of input port 211. Specifically, first photonic element 220 can be a first PIN photodiode. This first PIN photodiode 220 can include, for example, a first P-type region 221 and a first N-type region 222 within the sides of slab portion 216 and a first intrinsic region 223 extending laterally between first P-type region 221 and first N-type region 222 (i.e., through strip portion 215). Thus, an optical signal received at input port 211 will pass through first intrinsic region 223 between first P-type region 221 and first N-type region 222. If such a first PIN photodiode 220 is reverse biased (e.g., if first P-type region 221 is electrically connected to ground and if first N-type region 222 is biased with a positive bias voltage) as the optical signal passes through first intrinsic region 223, first PIN photodiode 220 can generate and output a first electrical parameter 225 and, particularly, a sense current (Isen). Furthermore, the level of Isen will be indicative of the power level of the optical signal. Thus, first PIN photodiode 220 is configured to detect the power level of the optical signal received at input port 210.

Second photonic element 230 can be an active photonic device in-line with (i.e., integrated with) waveguide 210 adjacent, but upstream of output port 212. Specifically, second photonic element 230 can be a second PIN photodiode. This second PIN photodiode 230 can include, for example, a second P-type region 231 and a second N-type region 232 within the sides of slab portion 216 and a second intrinsic region 233 extending laterally between second P-type region 231 and second N-type region 232 (i.e., through strip portion 215). Thus, before passing out of output port 212, an optical signal will pass through second intrinsic region 233 between second P-type region 231 and second N-type region 232. If such a second PIN photodiode 230 is forward biased (e.g., if second P-type region 231 is biased with a positive bias voltage and if second N-type region 232 is electrically connected to ground) as the optical signal passes through second intrinsic region 233, second PIN photodiode 230 can inject current into waveguide 210. If current is injected into the waveguide 210, free carriers will be created within the optical signal and, as a result, the power level of the optical signal will be reduced. In this case, the greater the level of the forward biasing, the greater the reduction in the power level of the optical signal. Those skilled in the art will recognize that such a forward biased second PIN photodiode 230 effectively functions as a single mode variable optical attenuator (VOA).

EIC 250 can include control circuitry 260 (also referred to herein as feed forward control circuitry or optical-electrical-optical control circuitry) electrically connected to first photonic element 220 (i.e., the first PIN photodiode) and second photonic element 230 (i.e., the second PIN photodiode. Specifically, control circuitry 260 can include a transimpedance amplifier (TIA) 270. TIA 270 can have input terminals, which are electrically connected to receive Isen 225 from first PIN photodiode and a reference current (Iref) 271 (e.g., from a reference current generator, not shown). Iref 271 can, for example, be predetermined so that it corresponds to an expected Isen when the power level of the optical signal is at a threshold power level (e.g., a maximum operating power level). TIA 270 can further be configured to compare Isen to Iref and to output a variable output voltage (Vout) 275 based on the difference between Isen and Iref. For example, TIA 270 can be configured to output a positive Vout when Isen is greater than Iref and can further be configured so that the positive voltage level of Vout increases proportionally as Isen rises above Iref. Control circuitry 260 can further include a bias voltage generator 280. Bias voltage generator 280 can be connected to receive Vout and can further be configured to generate a second electrical parameter 235 and, particularly, a variable bias voltage (Vbias) based on Vout. Second P-type region 231 of second PIN photodiode 230 can be electrically connected to receive Vbias to achieve forward biasing and, thus, to reduce the power level of the optical signal at output port 212 to at or below the threshold power level. It should be understood that bias voltage generator 280 can be calibrated to ensure that changes in Vout 275 will result in corresponding changes in Vbias 235 and cause second PIN photodiode 230 to inject an appropriate amount of current into waveguide 210 near output port 212, thereby creating a sufficient number of free carriers and reducing the power level to at or below the threshold power level.

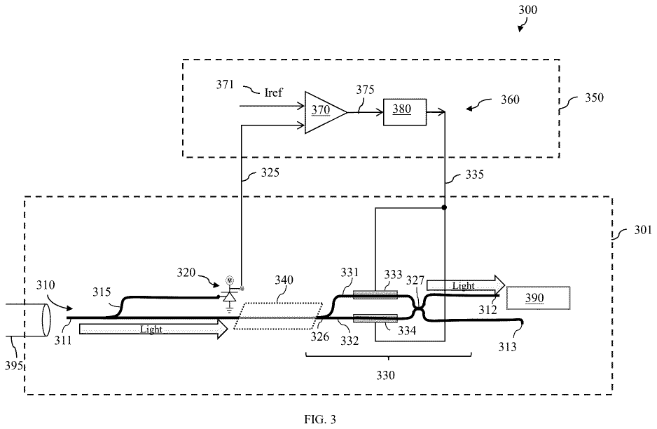

FIG. 3 is a schematic diagram illustrating an example of a CPO structure 300, according to other embodiments. CPO structure 300 includes: a photonic integrated circuit (PIC) 301 and an electronic integrated circuit (EIC) 350. PIC 301 can include a waveguide 310 and first and second photonic elements 320-330 and, more particularly, first and second PIN photodiodes (as discussed in greater detail below) coupled near input and output ports 311-312, respectively, of waveguide 310. EIC 350 can include control circuitry 360 connected between the first and second photonic elements 320-330 and configured to reduce the likelihood of and ideally prevent the occurrence of damage-causing over-power conditions within PIC 301.

More specifically, CPO structure 300 includes PIC 301. PIC 301 can include a waveguide 310 on a chip substrate. Waveguide 310 can include a core with any now known or subsequently developed waveguide shape. For example, core of waveguide 310 could have any of the following waveguide shapes: a strip shape (also referred to herein as wire shape), a rib shape (also referred to herein as a ridge shape), a slot shape, or a surface-wave (SW) shape. Waveguide 310 can include: a core material, which makes up the waveguide shape; and cladding material, which surrounds the core material. Such waveguide shapes are well known in the art and, thus, the details thereof have been omitted from the specification to allow the reader to focus on the salient aspects of the disclosed embodiments. In any case, the core of waveguide 310 can be surrounded by cladding in order to facilitate and control optical signal propagation along the core. The cladding material can have a smaller refractive index (n) than the core material that it surrounds. For example, the core material could be monocrystalline silicon with a refractive index of 3.3 to 3.6 and the cladding material could be a dielectric material with a smaller refractive index (e.g., silicon nitride with a refractive index of approximately 2.0). Alternatively, the core material could be silicon nitride with a refractive index of approximately 2.0 and the cladding material could be silicon dioxide with a refractive index of less than approximately 1.6. See additional discussion above regarding core and cladding materials with regard to waveguide 110 of FIG. 1.

In any case, waveguide 310 can further include an input port 311, a primary output port 312, and a secondary output port 313. Input port 311 can, for example, be coupled to an optical signal source 395 for receiving an optical signal. The optical signal source 395 could, for example, be an off-chip optical fiber (as illustrated). Such an off-chip optical fiber can be coupled to the input port 311 by a grating coupler, an edge coupler, an evanescent coupler, or any other suitable type of optical fiber-to-waveguide coupler. Alternatively, the optical signal source can be any other type of now known or subsequently developed optical signal source (e.g., a laser). Primary output port 312 can be coupled to at least one additional photonic element 390 of PIC 301. Additional photonic element 390 can be any type of active or passive photonic device coupled to the primary output port 312 of waveguide 310 to receive the optical signal. This additional photonic element 390 can have a predetermined maximum operating power level. That is, it may be susceptible to damage if a received optical signal waveguide 310 has a power level above the maximum operating power level. Secondary output port 313 can be a non-functional port.

PIC 301 can include first and second photonic elements 320-330 (also referred to herein as power detection and power reduction photonic elements) coupled to waveguide 310.

Specifically, first photonic element 320 can be an active photonic device coupled to a tap 315 off waveguide 310 adjacent, but downstream of input port 311. Specifically, first photonic element 320 can be a photodiode optically coupled to the end of the tap 315. It should be noted that tap 315 can include, for example, a power splitter. This power splitter can be configured so that the majority of the power of the optical signal continues along the primary signal pathway of waveguide 310, while only a small amount continues to the end of the tap 315. In some embodiments, this power splitter could be a 90:10 power splitter. That is, 90 percent of the power of the optical signal can continue along the primary signal pathway, while only 10 percent of the power continues to the end of the tap 315. Alternatively, the structure could be designed so that the power splitter has some different splitting percentage. For example, the power splitter could be an 80:20 splitter, an 85:15 splitter, a 95:5 splitter, etc. In any case, photodiode 320 can be reverse biased during sensing of the optical signal on tap 315 and can, thus, generate and output a first electrical parameter 325 and, particularly, a sense current (Isen). Furthermore, the level of Isen will be indicative of the power level of the optical signal.

Second photonic element 330 can be coupled to the primary signal path of waveguide 310 adjacent, but upstream of primary output port 312. Specifically, second photonic element 330 can include a combination of components. These components can include: a splitter 326 (e.g., a 50:50 splitter) downstream of input port 311; a coupler-splitter 327 (e.g., a two by two multi-mode interferometer (MMI) or other suitable type of coupler-splitter device); and a pair of waveguide branches (i.e., a first waveguide branch 331 and a second waveguide branch 332) extending between splitter 326 and coupler-splitter 327. At least one of waveguide branches 331-332 can include an integrated optical phase shifter. For purposes of illustration, FIG. 3 shows a first optical phase shifter 333 integrated into first waveguide branch 331 and a second optical phase shifter 334 integrated into second waveguide branch 332. However, it should be understood that the figures are not intended to be limiting and that, alternatively, only one of the waveguide branches 331-332 could have an integrated phase shifter. Optical phase shifter(s) 333-334 can be configured to control the phase of an optical signal passing therethrough in response to a second electrical parameter 335 (e.g., a bias voltage (Vbias)). Coupler-splitter 327 (e.g., a 2×2 MMI or similar device) can include a coupler section coupled to waveguide branches 331-332 and a splitter section coupled to primary and secondary output ports 312-313, respectively. Such a coupler-splitter 327 can be configured to route the optical signal in a predictable way. For example, in a default state, coupler-splitter 327 can route the entire optical signal to primary output port 312. However, if a second electrical parameter 335 (e.g., Vbias) to phase shifter(s) 333-334, phase shifting of the optical signal can occur in one or both waveguide branches 331-332 and, as a result, a portion of the optical signal can be rerouted away from primary output port 312 and toward secondary output port 313. As a result, the total power level of the optical signal at primary output port 312 will be reduced. By increasing the amount of phase shifting, the portion of the optical signal rerouted to secondary output port 313 can be increased.

EIC 350 can include control circuitry 360 (also referred to herein as feed forward control circuitry or optical-electrical-optical control circuitry) electrically connected to photodiode 320 and phase shifter(s) 333-334. Specifically, control circuitry 360 can include a transimpedance amplifier (TIA) 370. TIA 370 can have input terminals, which are electrically connected to receive Isen 325 from photodiode 320 and a reference current (Iref) 371 (e.g., from a reference current generator, not shown). Iref 371 can, for example, be predetermined so that it corresponds to an expected Isen off tap 315 when the power level of the optical signal is at a threshold power level (e.g., a maximum operating power level). TIA 370 can further be configured to compare Isen to Iref and to output a variable output voltage (Vout) 375 based on the difference between Isen and Iref. For example, TIA 370 can be configured to output a positive Vout when Isen is greater than Iref and can further be configured so that the positive voltage level of Vout increases proportionally as Isen rises above Iref. Control circuitry 360 can further include a bias voltage generator 380. Bias voltage generator 380 can be connected to receive Vout and can further be configured to generate a second electrical parameter 335 and, particularly, a variable bias voltage (Vbias) based on Vout. Phase shifter(s) 333-334 can be electrically connected to receive Vbias. In response to Vbias, phase shifter(s) 333-334 can cause phase shifting as light passes through waveguide branch(es) 331-332, respectively. As mentioned above, in response to phase shifting, coupler-splitter 327 can reroute at least a portion of the optical signal away from primary output port 312 in order to reduce the power level of the optical signal at primary output port 312 to at or below the threshold power level. It should be understood that bias voltage generator 380 can be calibrated so that changes in Vout 375 will cause corresponding changes in Vbias 335, and cause sufficient phase shifting and rerouting of the optical signal to reduce the power level of the optical signal at the primary output port 312 to at or below the threshold power level.

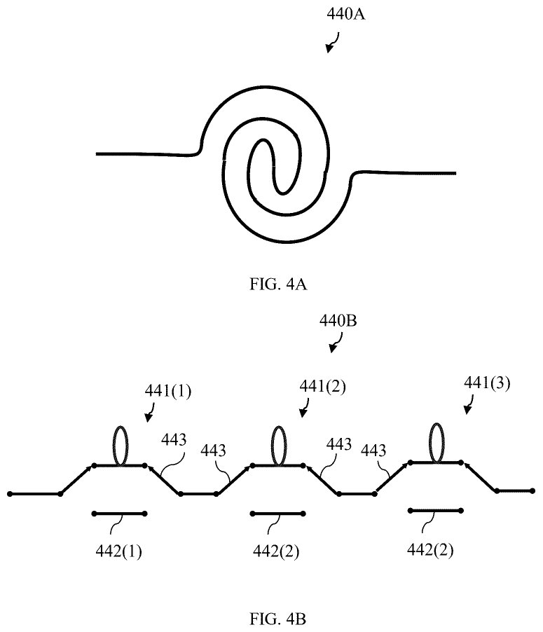

In the disclosed embodiment described above and illustrated in FIGS. 1-3, PIC 101, 201, 301 can also optionally include a delay line 140, 240, 340. Delay line 140, 240, 340 can be integrated into waveguide 110, 210, 310 downstream of input port 111, 211, 311 and upstream of second photonic element 130, 230, 330. Such a delay line 140, 240, 340 can, for example, be included to allow time for control circuitry 160, 260, 360 to generate second electrical parameter 135, 235, 335 and to further allow time for the power level of the optical signal to settle at the lower power level before being transmitted to additional photonic element 190, 290, 390. Various fixed and variable delay lines for optical signals are known in the art and could be integrated into waveguide 110, 210, 310, as mentioned above. For example, delay line 140, 240, 340 could be a spiral delay line 440A with a fixed amount of delay (e.g., as shown in FIG. 4A). Alternatively, delay line 140, 240, 340 could be a progressive delay line 440B, which includes multiple delay segments 441(1)-441(3) and bypass segments 442(1)-442(3) connectable in different combinations via optical switches 443 to selectively adjust the amount of delay.

It should be understood that the embodiments described above and illustrated in FIGS. 2-3 are provided for illustration purposes and not intended to be limiting. For example, in an alternative embodiment, not shown, a CPO structure could include: (1) a PIC including: a rib waveguide; a first photonic element including a PIN photodiode in line with a rib waveguide downstream of the input port (e.g., similar to the first photonic element 220 in FIG. 2); a second photonic element including a combination of phase shifter(s) and an MMI (e.g., similar to the second photonic element 330 in FIG. 3); and (2) an EIC including control circuitry between the first photonic element and the second photonic element. In another alternative embodiment, not shown, a CPO structure could include: (1) a PIC including: a rib waveguide; a first photonic element including a photodiode coupled to a tap downstream of the input port (e.g., similar to the first photonic element 320 in FIG. 3); a second photonic element including a PIN photodiode in line with the rib waveguide upstream of the output port (e.g., similar to the second photonic element 230 in FIG. 2); and (2) an EIC including control circuitry between the first photonic element and the second photonic element.

Processing techniques for forming PICs (including forming various active and passive components thereof such as waveguides, photodiodes and other photosensors, phase shifters, splitters, couplers, delay lines, etc.) are well known in the art and technology node-dependent. Similarly, processing techniques for forming EICs (including various active and passive components thereof such as electronic devices and circuits including interconnects, amplifiers, voltage generators, etc.) are also well known in the art and technology node-dependent. Thus, the details thereof have been omitted from the specification in order to allow the reader to focus on the salient aspects of the disclosed structure embodiments.

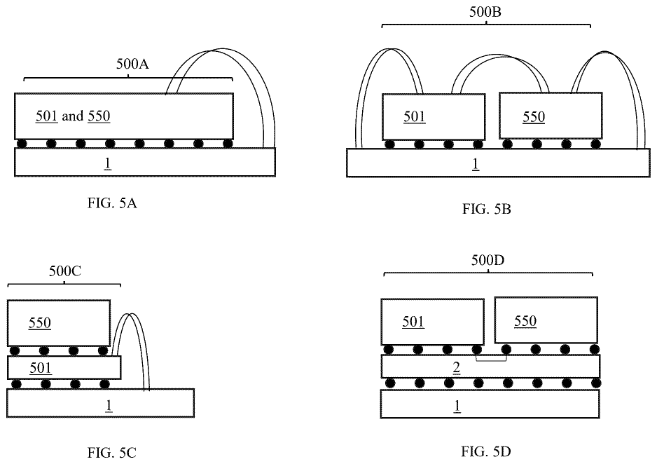

It should be noted that the CPO structures 100, 200, 300 of FIGS. 1-3 (each of which includes a PIC 101, 201, 301 and an EIC 150, 250, 350) can be implemented in any one of a variety of different configurations. For example, in a CPO structure configuration 500A, the PIC 501 and EIC 550 could be included in a monolithic chip that is mounted on a printed circuit board (PCB) 1 (see FIG. 5A). In another CPO structure configuration 500B, discrete chips for the PIC 501 and EIC 550 could be mounted side by side and electrically connected on a PCB 1 (see FIG. 5B). In another CPO structure configuration 500C, discrete chips for the PIC 501 and EIC 550 could be stacked vertically, electrically connected, and mounted on a PCB 1 (see FIG. 5C). In yet another CPO structure configuration 500D, discrete chips for the PIC 501 and EIC 550 could be mounted side by side and electrically connected on an interposer 2, which is further mounted on a PCB 1 (see FIG. 5D).

It should be understood that in the method and structures described above, a semiconductor material refers to a material whose conducting properties can be altered by doping with an impurity. Exemplary semiconductor materials include, for example, silicon-based semiconductor materials (e.g., silicon, silicon germanium, silicon germanium carbide, silicon carbide, etc.) and III-V compound semiconductors (i.e., compounds obtained by combining group III elements, such as aluminum (Al), gallium (Ga), or indium (In), with group V elements, such as nitrogen (N), phosphorous (P), arsenic (As) or antimony (Sb)) (e.g., GaN, InP, GaAs, or GaP). A pure semiconductor material and, more particularly, a semiconductor material that is not doped with an impurity for the purposes of increasing conductivity (i.e., an undoped semiconductor material) is referred to in the art as an intrinsic semiconductor. A semiconductor material that is doped with an impurity for the purposes of increasing conductivity (i.e., a doped semiconductor material) is referred to in the art as an extrinsic semiconductor and will be more conductive than an intrinsic semiconductor made of the same base material. That is, extrinsic silicon will be more conductive than intrinsic silicon; extrinsic silicon germanium will be more conductive than intrinsic silicon germanium; and so on. Furthermore, it should be understood that different impurities (i.e., different dopants) can be used to achieve different conductivity types (e.g., P-type conductivity and N-type conductivity) and that the dopants may vary depending upon the different semiconductor materials used. For example, a silicon-based semiconductor material (e.g., silicon, silicon germanium, etc.) is typically doped with a Group III dopant, such as boron (B) or indium (In), to achieve P-type conductivity, whereas a silicon-based semiconductor material is typically doped with a Group V dopant, such as arsenic (As), phosphorous (P) or antimony (Sb), to achieve N-type conductivity. A gallium nitride (GaN)-based semiconductor material is typically doped with magnesium (Mg) to achieve P-type conductivity and with silicon (Si) or oxygen to achieve N-type conductivity. Those skilled in the art will also recognize that different conductivity levels will depend upon the relative concentration levels of the dopant(s) in a given semiconductor region.

It should be understood that the terminology used herein is for the purpose of describing the disclosed structures and methods and is not intended to be limiting. For example, as used herein, the singular forms “a,” “an,” and “the” are intended to include the plural forms as well, unless the context clearly indicates otherwise. Additionally, as used herein, the terms “comprises,” “comprising,” “includes,” and/or “including” specify the presence of stated features, integers, steps, operations, elements, and/or components, but do not preclude the presence or addition of one or more other features, integers, steps, operations, elements, components, and/or groups thereof. Furthermore, as used herein, terms such as “right,” “left,” “vertical,” “horizontal,” “top,” “bottom,” “upper,” “lower,” “under,” “below,” “underlying,” “over,” “overlying,” “parallel,” “perpendicular,” etc., are intended to describe relative locations as they are oriented and illustrated in the drawings (unless otherwise indicated) and terms such as “touching,” “in direct contact,” “abutting,” “directly adjacent to,” “immediately adjacent to,” etc., are intended to indicate that at least one element physically contacts another element (without other elements separating the described elements). The term “laterally” is used herein to describe the relative locations of elements and, more particularly, to indicate that an element is positioned to the side of another element as opposed to above or below the other element, as those elements are oriented and illustrated in the drawings. For example, an element that is positioned laterally adjacent to another element will be beside the other element, an element that is positioned laterally immediately adjacent to another element will be directly beside the other element, and an element that laterally surrounds another element will be adjacent to and border the outer sidewalls of the other element. The corresponding structures, materials, acts, and equivalents of all means or step plus function elements in the claims below are intended to include any structure, material, or act for performing the function in combination with other claimed elements as specifically claimed.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various disclosed embodiments have been presented for purposes of illustration but are not intended to be exhaustive or limiting. Many modifications and variations will be apparent to those of ordinary skill in the art without departing from the scope and spirit of the disclosed embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
a photonic integrated circuit (PIC) including:
a waveguide having an input port and an output port;
a first photonic element coupled to the waveguide adjacent the input port, wherein the first photonic element detects a power level of an optical signal received at the input port;
a second photonic element coupled to the waveguide between the first photonic element and the output port; and
an electronic integrated circuit (EIC) connected to the first photonic element and the second photonic element, wherein, when the power level of the optical signal detected by the first photonic element is above a threshold power level, the EIC causes the second photonic element to reduce the power level of the optical signal adjacent to the output port.

2. The structure of claim 1, wherein the EIC causes the second photonic element to reduce the power level of the optical signal to at or below the threshold power level.

3. The structure of claim 1, wherein the waveguide is a silicon waveguide.

4. The structure of claim 1, wherein the waveguide is any of a strip waveguide and a rib waveguide.

5. The structure of claim 1, wherein the PIC further includes a delay line within the waveguide between the first photonic element and the second photonic element.

6. The structure of claim 1, wherein the input port is coupled to an optic fiber to receive the optical signal.

7. The structure of claim 1, wherein the PIC further includes at least one additional photonic element coupled to the output port to receive the optical signal, wherein the EIC includes control circuitry connected between the first photonic element and the second photonic element.

8. A structure comprising:
a photonic integrated circuit (PIC) including:
a waveguide having an input port and an output port;
a first photonic element coupled to the waveguide adjacent the input port, wherein the first photonic element detects a power level of an optical signal received at the input port and includes a first photodiode;
a second photonic element coupled to the waveguide between the first photonic element and the output port, wherein the second photonic element includes a second photodiode; and
an electronic integrated circuit (EIC) connected to the first photonic element and the second photonic element, wherein, when the power level of the optical signal detected by the first photonic element is above a threshold power level, the EIC causes the second photonic element to reduce the power level of the optical signal adjacent to the output port.

9. The structure of claim 8,
wherein the first photodiode includes a first PIN photodiode,
wherein the second photodiode includes a second PIN photodiode,
wherein the first PIN photodiode is reverse biased and generates a sense current,
wherein the EIC includes:
a transimpedance amplifier (TIA) connected to receive the sense current and a reference current, wherein, when the sense current is greater than the reference current indicating that the power level of the optical signal is above the threshold power level, the TIA outputs a variable output voltage; and
a bias voltage generator connected to receive the variable output voltage and to forward bias the second PIN photodiode with a corresponding variable bias voltage, wherein, due to forward biasing of the second PIN photodiode, additional current is injected into the waveguide to increase free carriers and reduce the power level to at or below the threshold power level.

10. The structure of claim 8, wherein the waveguide is a silicon waveguide.

11. The structure of claim 10,
wherein the silicon waveguide is a rib waveguide including a slab portion and a strip portion on and narrower than the slab portion,
wherein the first photodiode and the second photodiode include PIN photodiodes, and
wherein each PIN photodiode includes: a P-type region and an N-type region on opposite sides of the slab portion; and an intrinsic region in the strip portion positioned laterally between the P-type region and the N-type region.

12. The structure of claim 8, wherein the PIC further includes a delay line within the waveguide between the first photonic element and the second photonic element.

13. The structure of claim 8, wherein the input port is coupled to an optic fiber to receive the optical signal.

14. The structure of claim 8, wherein the PIC further includes at least one additional photonic element coupled to the output port to receive the optical signal, wherein the EIC includes control circuitry connected between the first photonic element and the second photonic element.

15. A method comprising:
providing a structure including:
a photonic integrated circuit (PIC) including: a waveguide having an input port and an output port; a first photonic element coupled to a tap on the waveguide adjacent the input port; and a second photonic element coupled to the waveguide between the tap and the output port, wherein the second photonic element includes: a splitter; a coupler-splitter; and a pair of waveguide branches extending between the splitter and the coupler-splitter, and wherein at least one of the waveguide branches includes at least one phase shifter; and
an electronic integrated circuit (EIC) connected to the first photonic element and the second photonic element;
detecting, by the first photonic element, a power level of an optical signal received at the input port; and
causing, by the EIC, the second photonic element to reduce the power level of the optical signal adjacent to the output port, when the power level of the optical signal detected by the first photonic element is above a threshold power level.

16. The method of claim 15,
wherein the first photonic element includes a photodiode and the detecting includes reverse biasing the photodiode to generate a sense current,
wherein the EIC includes a transimpedance amplifier connected to receive the sense current and a reference current and a bias voltage generator connected to the transimpedance amplifier and wherein the causing includes:
when the sense current is greater than the reference current indicating that the power level is above the threshold power level, outputting, by the transimpedance amplifier, a variable output voltage; and
receiving, by the bias voltage generator, the variable output voltage and outputting a corresponding variable bias voltage to the at least one phase shifter, wherein, due to biasing the at least one phase shifter, the coupler-splitter causes rerouting of a portion of the optical signal to a secondary output port to reduce the power level of the optical signal adjacent to the output port.

17. The method of claim 15, wherein the waveguide is a silicon waveguide.

18. The method of claim 15, wherein the PIC further includes a delay line within the waveguide between the tap and the second photonic element.

19. The method of claim 15, wherein the input port is coupled to an optical fiber to receive the optical signal.

20. The method of claim 15 wherein the PIC further includes at least one additional photonic element coupled to the output port to receive the optical signal, wherein the EIC includes control circuitry connected between the first photonic element and the second photonic element.
